(19) United States
(12) Patent Application Publication
(10) Pub. No.: US 2021/0402802 A1
(43) Pub. Date: Dec. 30, 2021

(54) CURL COMPENSATION THROUGH SELECTIVE INK USAGE

(71) Applicant: Hewlett-Packard Development Company, L.P., Spring, TX (US)

(72) Inventors: James M. Brenner, Vancouver, WA (US); Loreal E. Camp, Vancouver, WA (US); Morgan T. Schramm, Vancouver, WA (US)

(73) Assignee: Hewlett-Packard Development Company, L.P., Spring, TX (US)

(21) Appl. No.: 17/294,575

(22) PCT Filed: Mar. 1, 2019
(86) PCT No.: PCT/US2019/020409

§ 371 Date: May 17, 2021

(51) Int. Cl. B41J 11/00

(52) U.S. Cl. CPC B41J 11/0005; B41J 11/0015

(57) ABSTRACT

Examples of curl compensation through selective ink usage are described. In an example, whether curling is likely to occur on a printed page may be determined. The page may be printed using a first ink lacking anti-curl properties and a second ink having anti-curl properties in response to determining that curling is likely to occur.

### BACKGROUND

Printing devices may apply a print substance, which can include printing agents or colorants, to a printed media sheet such as paper. A printing device may include a black print substance and/or color print substances. In some examples, some inks used by a printing device may include anti-curl properties and other inks may lack anti-curl properties.

### BRIEF DESCRIPTION OF THE DRAWINGS

FIG. 1 is a block diagram of an example of a printing device that may be used for curl compensation through selective ink usage;

FIG. 2 is a block diagram of an example of an apparatus that may be used in an example of a method for curl compensation through selective ink usage;

FIG. 3 is a flow diagram illustrating an example of a method for curl compensation through selective ink usage;

FIG. 4 is a flow diagram illustrating another example of a method for curl compensation through selective ink usage;

FIG. 5 is a flow diagram illustrating yet another example of a method for curl compensation through selective ink usage; and

FIG. 6 illustrates an example of ink substitution for curl compensation.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Printing devices—including printers, copiers, fax machines, multifunction devices including additional scanning, copying, and finishing functions, all-in-one devices, and pad printers to print images on three dimensional objects—apply a print substance, which can include printing agents or colorants, to a substrate. A substrate is a superset of print media, such as plain paper, and can include any suitable object or materials to which a print substance from a printing device is applied. For ease of explanation, a substrate is referred to herein as a “page.” Print substances, including printing agents and colorants, are a superset of inks and can include liquid inks, or other suitable marking material that may or may not be mixed with fusing agents, detailing agents, or other materials and can be applied to the substrate. For ease of explanation, a print substance is referred to herein as “ink.”

This disclosure relates to methods for mitigating curling of a page by selective ink usage. In some cases, applying ink on a page may result in curling. Some inks used by a printing device may include anti-curl properties while other inks may lack these anti-curl properties. To minimize curling, the usage of an ink used to print certain regions of a page may be modified. For example, a region may be identified in which curling is likely to occur. Then, an ink (or a combination of inks) having anti-curl properties may be used along with an ink lacking the anti-curl properties.

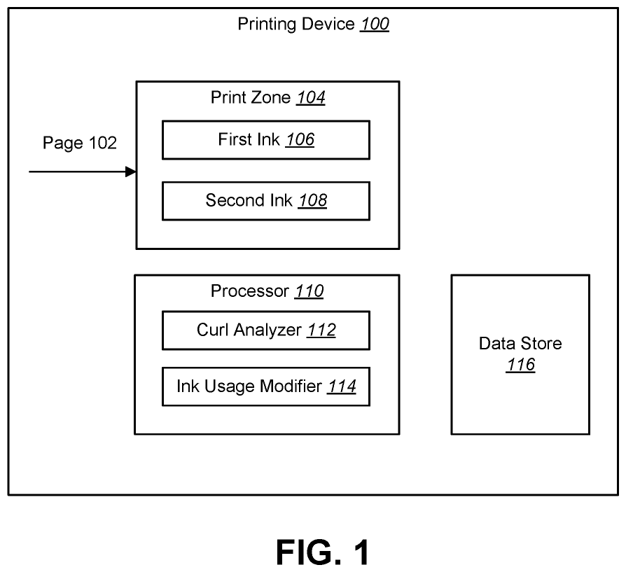

FIG. 1 is a block diagram of an example of a printing device 100 that may be used for curl compensation through selective ink usage. The printing device 100 (e.g., a page-wide inkjet printer) may modify how it prints a page 102 based on the likelihood that curl will occur.

The printing device 100 may include a processor 110. In some examples, the processor 110 may be a computing device, a semiconductor-based microprocessor, a central processing unit (CPU), a graphics processing unit (GPU), field-programmable gate array (FPGA), an application-specific integrated circuit (ASIC), and/or other hardware device. The processor 110 may be connected to other components of the printing device 100 via communication lines (not shown).

The processor 110 may control motors and/or actuators (not shown) to control operations of the components of the printing device 100. For example, the processor 110 may control a motor (not shown) that determines the speed of printing in a print zone 104. The processor 110 may also control actuators that control the deposition of ink on the page 102. The processor 110 may also control actuators that control the feeding of ink into the printhead(s) (not shown). The processor 110 may further control conditioning processes in a conditioner and/or finishing operations in a finisher.

As used herein, the print zone 104 is a region of the printing device 100 that includes components to deposit ink to the page 102. The print zone 104 may include a number of printheads.

The processor 110 may communicate with a data store 116. The data store 116 may be a machine-readable storage medium. Machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like. The data store 116 may be referred to as memory.

The data store 116 may include data pertaining to the page 102. For example, the data store 116 may store data pertaining to images to be printed on a printed side of the page 102. In an example of a duplex page 102, the data store 116 may store data pertaining to images to be printed on a first side and a second side of the page 102.

As described below, a machine-readable storage medium may also be encoded with executable instructions for curl compensation through selective ink usage. For example, the data store 116 may include machine-readable instructions that cause the processor 110 to determine that curling is likely to occur on a printed page 102. The data store 116 may also include machine-readable instructions that cause the printing device 100 to print the page 102 using a first ink 106 lacking anti-curl properties and a second ink 108 having anti-curl properties in response to determining that curling is likely to occur.

In some cases, moisture from the ink may interact with the media substrate to negatively impact the quality of the media substrate. For example, ink moisture may produce a curled media in addition to creating a soft, soggy feel to the page. The curling caused by ink moisture may also result in difficulties when a page 102 is compiled in a finisher (not shown). As used herein, “compile” refers to organizing or grouping a number of printed pages. Finishing operations may also include stacking and/or stapling pages.

Curl is a property of paper that relates to its flatness. When laying a sheet, or stack of sheets, on a flat surface such as a desktop, the sheets should lay flat on the surface. Curl is the measurement of a lack of flatness where some portion of the page 102 curves away from the flat surface. In extreme curl, the page 102 may even wrap on itself forming a roll. Curl is undesirable in finished output. Curl is difficult to handle in a mechanism (e.g., printing device 100) designed to handle a flat page 102.

When paper is manufactured, there is tension between the fibers of the paper. When the paper dries, the fibers lock together. This puts the paper under tension. When an ink wets the page 102 during printing, the tension in the paper fibers is released. When this occurs, the page 102 may curl. Usually the page 102 curls away from the ink side and to the dry side. The curl may be especially severe when the ink wets the page 102 unevenly (e.g., one side of the page 102 is wet while the other side is not wet).

When printing on paper, the action of adding ink can cause the paper to curl. Adding ink uniformly across a page 102 may result in a soft, soggy page, but a page 102 that does not curl significantly. However, adding ink to select locations on a page 102 (referred to herein as regions) will create a non-uniform stress load across the fiber web within the paper. This non-uniform stress may result in a curl. For example, curl may occur when ink is deposited along one side of a page 102, but not the other side of the page 102.

The resulting curl may present challenges for both the mechanism (e.g., printing device 100) and the end user. Curled pages 102 are more difficult for the mechanism to successfully process without causing a jam or user intervention. Even if curled pages 102 are outputted successfully, they may be less desirable for the end user as the curled pages 102 have worse handle-ability, stack-ability and/or visual appearance as compared to flat pages 102.

In some approaches, inks may have anti-curl properties to inhibit curl. For example, for inks with anti-curl properties, materials or chemicals may be added to the inks that help to prevent curl. For example, these anti-curl agents may help to prevent the formation of stresses, or to evenly distribute the stresses caused by printing and thus reduce curl.

Not all inks have anti-curl agents, nor are all inks chemically or visually compatible with the various anti-curl agents. Furthermore, in some cases the anti-curl agents are incompatible with other aspects of the ink. For example, issues with shelf life, material compatibility, or visual attributes such as optical density may be adversely affected by the addition of these anti-curl agents. Therefore, trade-offs in curl performance are made against performance attributes in other areas of printing when formulating and using inks.

In some approaches, anti-curl agents are used in all of the ink that is used in by the printing device 100. In these approaches, when anti-curl agents are incompatible with an ink, mechanical additions to the printing device 100 are made to compensate for curly pages. These mechanical additions may include extra rollers, surfaces, dryers, fusers, and hold-downs. These mechanical additions result in additional cost, complexity, and/or reduced performance of the printing device 100. The methods described herein overcome these deficiencies by selectively modifying which inks are used in certain regions of the page 102 to minimize the formation of curl.

With the methods described herein, the ink on the page 102 may be locally modulated to reduce curl in the output. These changes to the ink can include reducing the amount of curl-inducing ink or substituting portions of a curl-inducing ink for another ink that is more curl inhibiting. Therefore, alternate inks may be used to substitute their curl-reducing properties for inks that lack anti-curl agents. For example, a black ink may lack anti-curl agents while color inks (e.g., cyan and/or magenta) may include anti-curl agents. A color ink having the anti-curl properties may be used to compensate for these missing anti-curl properties of the black ink. In an example, some extra color ink may be added in high density or leading edge areas where black ink alone would cause unacceptable curl.

The print zone 104 of the printing device 100 may use a first ink 106 ink lacking anti-curl properties and a second ink 108 having anti-curl properties. For example, the first ink 106 may be a black ink lacking an anti-curl agent. The second ink may be a color ink (e.g., cyan or magenta) that includes an anti-curl agent.

The processor 110 may include a curl analyzer 112. The curl analyzer 112 may determine whether curling is likely to occur on a printed page 102. In some examples, determining whether curling is likely to occur may be based on a region of the page 102. In other words, the curl analyzer 112 may determine whether the page 102 is likely to curl due to the application of the first ink 106 based on where the first ink 106 is to be applied.

In this approach, the curl analyzer 112 may determine whether the first ink 106 lacking anti-curl properties will be printed in a region of the page 102 that is likely to curl. Certain regions of the page 102 may be identified as likely to produce curl if printed. For example, curl on the bottom edge and/or top edge of the page 102 may be troublesome for a finishing operation (e.g., stapler and/or stacker), which leads to an increased frequency of jams. For the finishing operation, dense areas of the first ink 106 ink lacking anti-curl properties (e.g., black ink) printing in the bottom portion of the page 102 are likely to result in curling.

Other regions of the page 102 may also be known to cause curling. For example, a high concentration of the first ink 106 on the edges of the page 102 may be likely to cause curling. The curl analyzer 112 may determine whether or not the first ink 106 is to be applied in a region of the page 102 that is likely to cause curling.

When determining whether printing in a region of the page 102 is likely to cause curling, various parameters may be considered. For example, the page 102 may be subdivided into multiple regions. The regions may be defined by a length, width and/or location on the page. In an example, a top region may be located at the top of the page 102. The top region may be defined as a rectangular block that spans the width of the page 102 and has a length of two inches. It should be noted that this is one example of how a region may be defined. This top region may be defined with other dimensions. Furthermore, other regions may also be defined on the page 102.

Certain patterns of the first ink 106 may be likely to cause curling of the page 102. As used herein a “pattern” refers to a variation in the amount of ink deposited in one region of the page 102 as compared to another region of the page 102. In some examples, the curl analyzer 112 may determine whether the first ink 106 is to be deposited on the page 102 with a certain pattern that is likely to cause curling. For example, if a certain region of the page is to have a large concentration of the first ink 106 and this region borders another region that does not include the first ink 106, then the curl analyzer 112 may identify this case as likely to cause curling. Therefore, determining that curling is likely to occur on the printed page 102 may include determining that the first ink 106 lacking anti-curl properties will be printed in a region of the page 102 but not in another region of the page 102.

In an example, a pattern that is likely to cause curl may include a two-inch block of black ink that borders a region of white where no (or minimal) ink is deposited on the page 102. It should be noted that the dimensions in this example are provided for illustrative purposes and may vary based on ink formulation, media properties, print speed and other print properties.

In some examples, determining that curling is likely to occur on the printed page 102 may include determining that a print density of the first ink 106 lacking anti-curl properties exceeds a threshold. As used herein, the print density is an amount of deposited ink within a region of the page 102. For example, using the first ink 106 to produce text may not be likely to cause curling because the print density is less than a threshold. However, a certain amount of the first ink 106 may be likely to cause curling of the page 102. The curl analyzer 112 may determine if the print density of the first ink 106 would exceed a threshold indicating that curling is likely. It should be noted that the print density threshold may be dependent on the particular formulation of the agents, colorants, and/or inks used.

Using ink-based printing as an illustrative example, in some implementations, the print density may be measured as the predicted number of ink droplets to be deposited within a region of the page 102. In an implementation, the print density may be expressed as a number of ink droplets per unit area (e.g., mm²) within a region of the page 102. In this example, the print density threshold may also be expressed as a number of ink droplets within the region. If the predicted number of ink droplets to be deposited within a region of the page 102 exceeds the print density threshold, then this may be an indication that curling is likely to occur on the printed page 102.

In some other examples, the print density may be measured as the predicted mass (e.g., nanograms) of deposited ink. In this case, the print density threshold may also be expressed as a mass of deposited ink. If the predicted mass of ink to be deposited within a region of the page 102 exceeds the print density threshold, then this may be an indication that curling is likely to occur on the printed page 102.

In yet another example, the print density may be measured as the predicted volume (e.g., nanoliters) of ink to be deposited within a region of the page 102. In this case, the print density threshold may also be expressed as a volume of deposited ink. If the predicted volume of ink to be deposited within a region of the page 102 exceeds the print density threshold, then this may be an indication that curling is likely to occur on the printed page 102. Of course, the foregoing could apply similarly for other agents and colorants.

In some examples, determining that curling is likely to occur on the printed page 102 may be based on the print density and the region of the first ink 106. For example, the curl analyzer 112 may consider both the region (e.g., the location on the page 102) of the first ink 106 and the print density (e.g., the amount of the first ink 106 in the region). The curl analyzer 112 may weight certain regions and print densities differently. For example, a region that is located at either the top or bottom edge of the page 102 may be weighted higher than a region located in the center of the page 102. In another example, a low print density may have a lower weight than a high print density. The curl analyzer 112 may determine a weighted score for various regions based on the location of the region and the print density of the first ink 106 in the region. If the weighted score of a region exceeds a certain threshold, then curling is likely to occur.

In some examples, the placement of the first ink 106 on a duplex page 102 may be used to determine the likelihood of curling. The curl analyzer 112 may take into consideration the region(s) and print densities of the first ink 106 on both sides of the page 102 when determining whether curling is likely to occur. For example, if the first ink 106 is to be deposited in one region on one side of the page 102 and not in another region of the second side of the page 102, then curling may be likely to occur. In another example, certain print densities on both sides of the page 102 may be likely to produce curling.

The processor 110 may include an ink usage modifier 114. The ink usage modifier 114 may cause the printing device 100 to print the page 102 using the first ink 106 lacking anti-curl properties and a second ink 108 having anti-curl properties in response to determining that curling is likely to occur. For example, for pages 102 with a certain pattern and/or print density of the first ink 106, an amount of the second ink 108 may be substituted for an amount of the first ink 106 during printing. This approach may be referred to as ink substitution. This approach may also be referred to as replacement printing as a certain amount of the first ink 106 is replaced by the second ink 108.

In the case where the first ink 106 is a black ink and the second ink 108 is a color ink (e.g., magenta and/or cyan ink), an amount (e.g., a percentage) of the black ink may be substituted for the color ink in a portion of the page 102. The result is that the black areas curl less due to the anti-curl properties within the color ink, but the region still retains its black color and density. In an example, the black ink may be reduced by 10%-25% and replaced by a corresponding amount of color ink. For instance, if the black ink is reduced by 25%, then the difference may be replaced by a color ink (e.g., magenta and/or cyan ink). Therefore, the region may be printed by using 75% black ink and 25% color ink. It should be noted that the values used in this example are provided for illustrative purposes.

The amount of ink substitution used to mitigate curl may vary based on various print properties. For example, ink formulation, media properties, mechanical page conditioning and/or print speed may impact the amount of ink substitution used.

In other examples, the printing device 100 may perform under printing using an additional amount of the second ink 108 having anti-curl properties to mitigate page curling. The ink usage modifier 114 may cause the printing device 100 to print an amount of the first ink 106 overlapping with an additional amount of the second ink 108 having anti-curl properties. In other words, the second ink 108 may be applied in addition to an unmodified amount of the first ink 106. This approach may be referred to as under printing. It should be noted that in this approach, the first ink 106 may be deposited before, concurrently or after depositing the second ink 108.

In an example of under printing where the first ink 106 is a black ink and the second ink 108 is a color ink (e.g., magenta and/or cyan ink), a percentage of color ink may be added to the full amount of black ink. For example, the amount of additional color ink may be between 10%-25% of the amount of black ink. For instance, the region may be printed by using 100% black ink and an additional 25% color ink.

In some examples, the amount of ink substitution or under printing may be configurable. For example, a high amount (e.g., 25%) of ink substitution or under printing may be performed for some pages 102 and/or regions of a page 102 while a low amount (e.g., 10%) of ink substitution or under printing may be performed for other pages 102 and/or regions of a page 102. In some examples, the amount of ink substitution or under printing may be user-selectable.

In some examples, the amount of ink substitution or under printing may be based on finishing operations that will be applied to a page 102. For example, if pages 102 are to be stapled, then a high amount of ink substitution or under printing may be performed to ensure that the pages 102 are flat for the stapler. However, if a page 102 is to be output to an output bin without additional finishing, then a low amount of ink substitution or under printing may be performed. In this case, a certain amount of curl may be acceptable.

In some examples, the ink usage modification (e.g., ink substitution or under printing) may be performed for all documents and/or images. In other words, the ink usage modifier 114 may cause the printing device 100 to print with both the first ink 106 and the second ink 108 whenever the first ink 106 is used.

In other examples, the ink usage modification (e.g., ink substitution or under printing) may be performed when the curl analyzer 112 determines that a page 102 or a region of the page 102 is likely to experience curling from the first ink 106. For example, once an ink pattern is determined likely to cause curling, or the page 102 is deemed suspect for curl, the ink usage modifier 114 may cause the printing device 100 to print with both the first ink 106 and the second ink 108 to mitigate the curl.

A combination of the first ink 106 lacking anti-curl properties and the second ink 108 having anti-curl properties may be selected to match an original color. In some examples, the ink usage modifier 114 may cause the printing device 100 to print the page 102 using an alternate colormap. For example, the alternate colormap may translate a color (e.g., black or other color) using the first ink 106 lacking anti-curl properties to a combination of the first ink 106 and the second ink 108 having anti-curl properties. The alternate colormap may cause to device 100 to print the page 102 using ink substitution or under printing of the first ink 106 and the second ink 108 as described above.

In other examples, the ink usage modifier 114 may cause the printing device 100 to perform ink substitution or under printing without using an alternate colormap. In this approach, the ink usage modifier 114 may substitute a certain amount of the second ink 108 to be substituted for the first ink 106 upon identifying a high-curl probability. For example, the ink usage modifier 114 may look at the channel of the first ink 106 that is generated by the existing colormap. The ink usage modifier 114 may then substitute a certain percentage of the first ink 106 for the second ink 108. Alternatively, the ink usage modifier 114 may add a certain amount of the second ink 108 to the first ink 106 upon identifying a high-curl probability. In these approaches, instead of building an alternate colormap or modifying the existing colormap, a new signal for the first ink 106 may be generated on-the-fly.

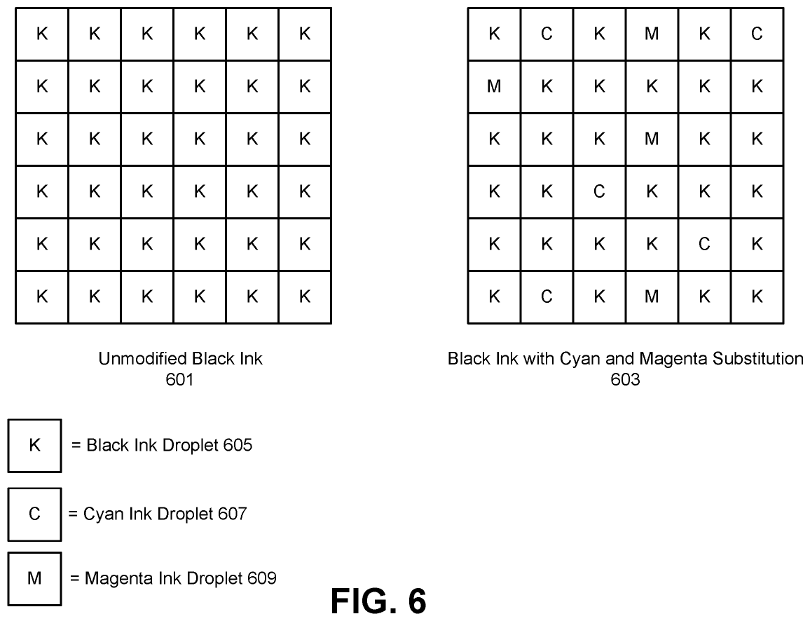

In some examples, a combination of multiple inks having anti-curl properties may be used to mitigate the curl-inducing effects of the first ink 106. For example, the ink usage modifier 114 may cause the printing device 100 to print the page 102 using the first ink 106, the second ink 108 and a third ink having anti-curl properties in response to determining that curling is likely to occur. In an example, the first ink 106 may be a black ink. The second ink 108 and the third ink may be magenta and cyan. An example of this approach is described in connection with FIG. 6.

In some examples, the page 102 may be printed using the first ink 106 lacking anti-curl properties and the second ink 108 having anti-curl properties based on a finishing operation for the page 102. For example, when determining whether to perform the modified printing (e.g., ink substitution or under printing), this determination may also be based on the destination of the page 102. Pages 102 that are going to a standard output bin may not be as sensitive to curl. However, for pages 102 that are going to be stapled in a finisher, pages 102 may have to be carefully lined up and collated before the staple is driven through. Therefore, the modified printing described herein may be of particular interest for stapled jobs or print jobs that include other finishing processes (e.g., cutting, binding, output offset, etc.).

In some examples, the modified printing may also be a user-selectable feature. For example, a user may choose to enable the modified printing to provide extra-flat output.

The described methods for curl compensation through selective ink usage provide for reduced page curl, increased page flatness and reduced user intervention for regions of a document and/or documents with a predicted curl likelihood above a threshold. Additionally, cost and performance penalties may be avoided by not adding anti-curl additives to inks that are incompatible. Furthermore, cost and system complexity are also reduced because additional curl controlling mechanisms (e.g., extra rollers, surfaces, dryers, fusers and/or hold-downs) may be avoided.

As described above, in some examples the printing device 100 may be a page-wide inkjet printer. In other examples, the printing device 100 may be a scanning inkjet printer in which the printhead(s) of the printing device 100 move to different locations of the page 102. It should be noted that the described methods for modified printing may provide for enhanced curl compensation in page-wide inkjet printing and scanning inkjet printing. But with page-wide inkjet printing, the described methods for modified printing may provide for curl compensation without a scanning printhead.

The printing device 100 may include additional components (not shown). Further, some of the components described herein may be removed and/or modified without departing from the scope of this disclosure. The printing device 100 as depicted in FIG. 1 may not be drawn to scale and may have a different size and/or configuration than shown. In another example, the printing device 100 may use any of a number of printing techniques where moisture is added to the page. For example, the printing device 100 may be an inkjet printer.

In addition, the apparatuses disclosed herein for curl compensation through selective ink usage may be external to the printing device 100. For instance, the apparatuses disclosed herein may be computing device(s) that are external to the printing device 100. The external computing device(s) may determine that curling is likely to occur on the printed page 102. The disclosed apparatuses may then cause the printing device 100 to print the page 102 using the first ink 106 lacking anti-curl properties and the second ink 108 having anti-curl properties in response to determining that curling is likely to occur.

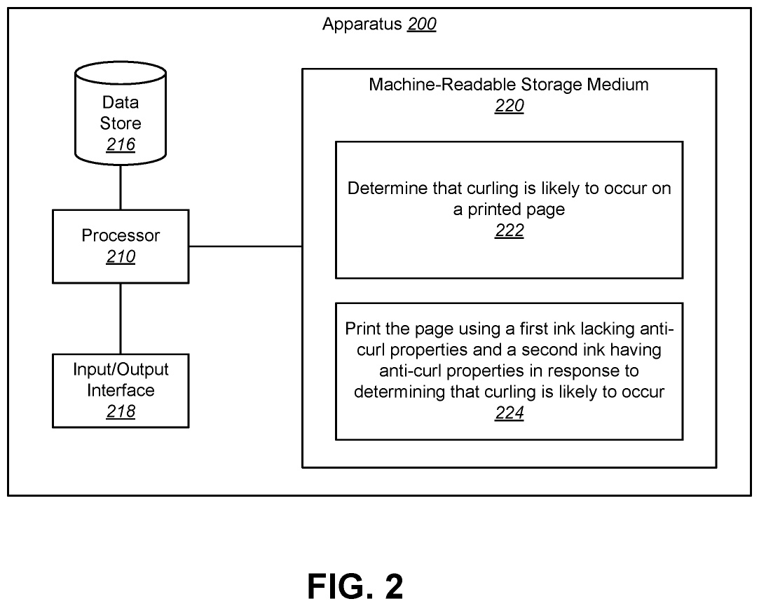

FIG. 2 is a block diagram of an example of an apparatus 200 that may be used in an example of a method for curl compensation through selective ink usage. The apparatus 200 may be a computing device, such as a personal computer, a server computer, a printer, a smartphone, a tablet computer, etc. In an example, the apparatus 200 may be equivalent to the printing device 100 and/or the processor 110 depicted in FIG. 1. The apparatus 200 may include a processor 210, a data store 216, an input/output interface 218, and a machine-readable storage medium 220. The apparatus 200 may further include additional components (not shown) and some of the components described herein may be removed and/or modified without departing from the scope of this disclosure.

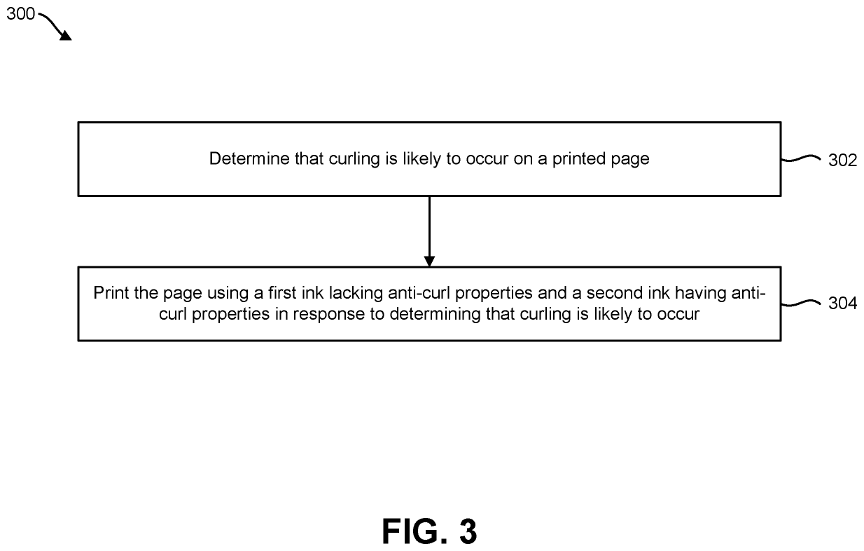

The processor 210 may be any of a central processing unit (CPU), a semiconductor-based microprocessor, GPU, FPGA, an application-specific integrated circuit (ASIC), and/or other hardware devices suitable for retrieval and execution of instructions stored in the machine-readable storage medium 220. The processor 210 may fetch, decode, and execute instructions, such as instructions 222-224 stored on the machine-readable storage medium 220, to control processes to determine 222 that curling is likely to occur on a printed page; and print 224 the page using a first ink lacking anti-curl properties and a second ink having anti-curl properties in response to determining that curling is likely to occur. As an alternative or in addition to retrieving and executing instructions, the processor 210 may include an electronic circuit and/or electronic circuits that include electronic components for performing the functionalities of the instructions 222-224. These processes are described in detail below with respect to FIGS. 3-6.

The machine-readable storage medium 220 may be any electronic, magnetic, optical, or other physical storage device that contains or stores executable instructions. Thus, the machine-readable storage medium 220 may be, for example, RAM, EEPROM, a storage device, an optical disc, and the like. In some implementations, the machine-readable storage medium 220 may be a non-transitory machine-readable storage medium, where the term “non-transitory” does not encompass transitory propagating signals.

The apparatus 200 may also include a data store 216 on which the processor 210 may store information, such as information pertaining to the images to be printed. The data store 216 may be volatile and/or non-volatile memory, such as DRAM, EEPROM, MRAM, phase change RAM (PCRAM), memristor, flash memory, and the like.

The apparatus 200 may further include an input/output interface 218 through which the processor 210 may communicate with an external device(s) (not shown), for instance, to receive and store the information pertaining to the images to be printed. The input/output interface 218 may include hardware and/or machine-readable instructions to enable the processor 210 to communicate with the external device(s). The input/output interface 218 may enable a wired or wireless connection to the external device(s). The input/output interface 218 may further include a network interface card and/or may also include hardware and/or machine-readable instructions to enable the processor 210 to communicate with various input and/or output devices, such as a keyboard, a mouse, a display, another computing device, etc., through which a user may input instructions into the apparatus 200.

FIG. 3 is a flow diagram illustrating an example of a method 300 for curl compensation through selective ink usage. The method 300 for curl compensation through selective ink usage may be performed by, for example, the processor 110 and/or the apparatus 200.

The apparatus may determine 302 that curling is likely to occur on a printed page 102. For example, the apparatus may determine that a print density of a first ink 106 lacking anti-curl properties exceeds a threshold. A certain amount of the first ink 106 deposited in a region of the page 102 may be likely to cause curling of the page 102. The apparatus may determine if the print density (e.g., the amount of deposited ink within a region of the page 102) of the first ink 106 would exceed a threshold indicating that curling is likely.

In another example, the apparatus may determine that the first ink 106 lacking anti-curl properties will be printed in a region of the page 102 that is likely to curl. In other words, the apparatus may determine whether the page 102 is likely to curl based on where the first ink 106 is to be applied to the page 102. A region and/or regions of the page 102 may be identified with a predicted curl likelihood above a threshold. The apparatus may determine if the first ink 106 is to be applied in a certain region of the page 102 that is likely to curl as a result of the ink application.

In yet another example, the apparatus may determine that the first ink 106 will be printed in a region of the page 102 but not in another region of the page 102. In this approach, the apparatus may determine whether the first ink 106 is to be deposited on the page 102 with a certain pattern that is likely to cause curling.

The apparatus may print 304 the page 102 using the first ink 106 lacking anti-curl properties and a second ink 108 having anti-curl properties in response to determining that curling is likely to occur. In some examples, the first ink 106 may be a black ink lacking an anti-curl agent and the second ink 108 may be a color ink (e.g., cyan or magenta ink) that includes an anti-curl agent.

In an example, the apparatus may substitute an amount of the first ink 106 lacking anti-curl properties with an amount of the second ink 108 having anti-curl properties during printing. In this approach, a certain percentage of the first ink 106 may be substituted with the second ink 108 when printed.

In another example, the apparatus may print 304 an amount of the first ink 106 lacking anti-curl properties overlapping with an additional amount of the second ink 108 having anti-curl properties. In this approach, the second ink 108 may be applied in addition to an unmodified amount of the first ink 106. It should be noted that in this approach the first ink 106 may be deposited before, concurrently or after deposition of the second ink 108.

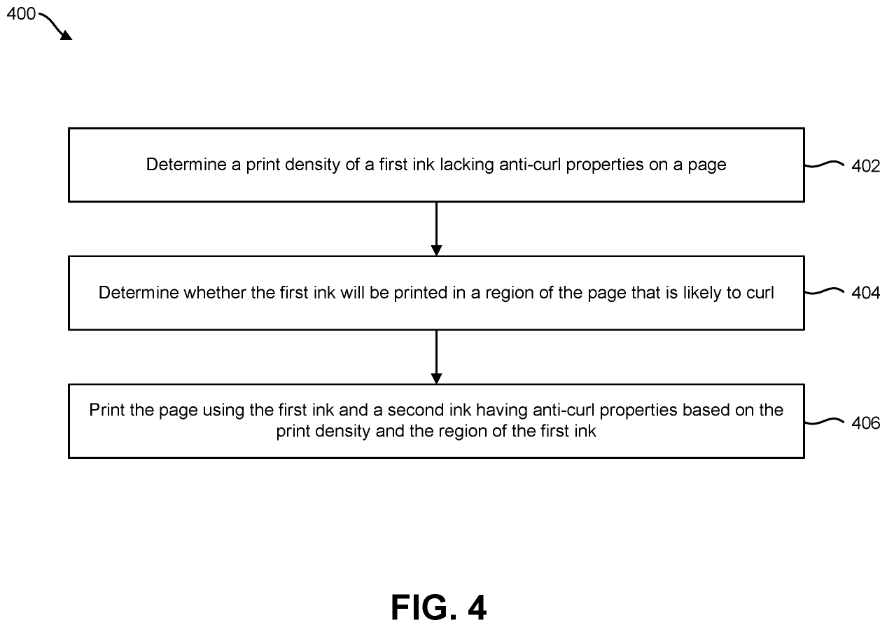

FIG. 4 is a flow diagram illustrating another example of a method 400 for curl compensation through selective ink usage. The method 400 for curl compensation through selective ink usage may be performed by, for example, the processor 110 and/or the apparatus 200.

The apparatus may determine 402 a print density of a first ink 106 lacking anti-curl properties on a page 102. For example, the apparatus may determine an amount of the first ink 106 that is to be printed in a region of the page 102. In other words, the print density of the first ink 106 is a predicted amount of the first ink 106 that is to be printed in a region of the page 102. The apparatus may determine the print density of a first ink 106 before printing commences.

The apparatus may determine 404 whether the first ink 106 will be printed in a region of the page 102 that is likely to curl. For example, a high concentration of the first ink 106 on the edges of the page 102 may be likely to cause curling. Other regions of the page 102 may also be known to cause curling.

The apparatus may weight certain regions and print densities differently. For example, a region that is located on an edge of the page 102 may be weighted higher than region located in the center of the page 102. In another example, a low print density may have a lower weight than a high print density. The apparatus may determine a weighted score for various regions based on the location of the region and the print density of the first ink 106. If the weighted score of a region exceeds a certain threshold, then curling is likely to occur.

The apparatus may print 406 the page 102 using the first ink 106 and a second ink 108 having anti-curl properties based on the print density and the region of the first ink 106. For example, a combination of the first ink 106 and the second ink 108 may be used in response to determining that the print density of the first ink 106 exceeds a threshold and the first ink 106 will be printed in a region of the page that is likely to curl.

The apparatus may print 406 the page 102 using a combination of the first ink 106 and the second ink 108 through either ink substitution or under printing. This may be accomplished as described in connection with FIG. 1.

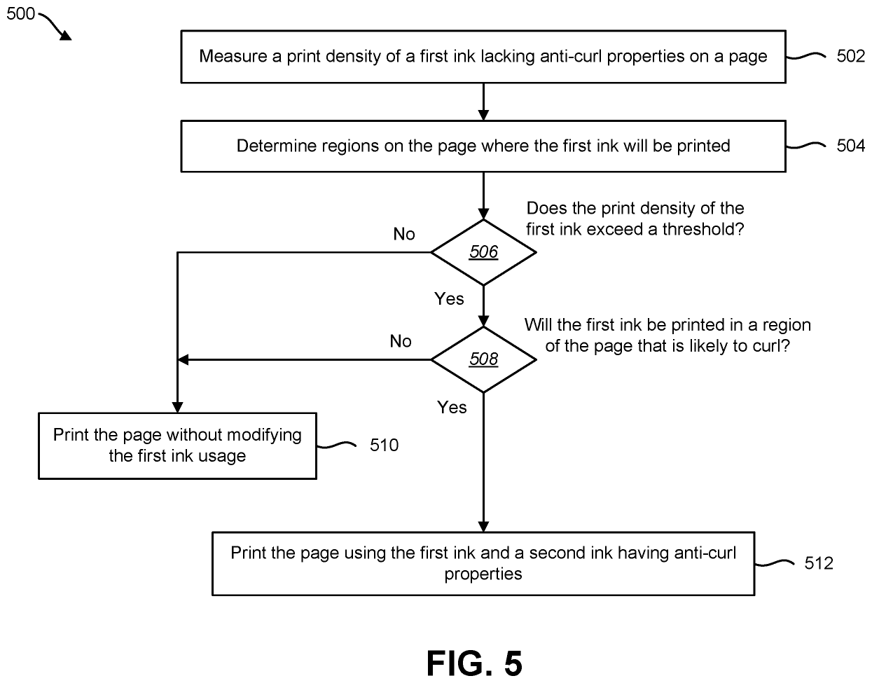

FIG. 5 is a flow diagram illustrating yet another example of a method 500 for curl compensation through selective ink usage. The method 500 for curl compensation through selective ink usage may be performed by, for example, the processor 110 and/or the apparatus 200.

The apparatus may measure 502 a print density of a first ink 106 lacking anti-curl properties on a page 102. For example, the apparatus may determine an amount of the first ink 106 that is to be printed in a region of the page 102.

The apparatus may determine 504 regions on the page 102 where the first ink 106 will be printed. For example, the apparatus may segment the page 102 into different regions. Examples of regions include edges and the center of the page 102.

The apparatus may determine 506 whether the print density of the first ink 106 exceeds a threshold. For example, the apparatus may determine if an amount of the first ink 106 that is to be printed in a region of the page 102 exceeds a threshold. If the print density of the first ink 106 does not exceed the threshold, then the apparatus may print 510 the page 102 without modifying the first ink usage. In other words, the apparatus may print 510 the page without adding or substituting the second ink 108.

If the apparatus determines 506 that the print density of the first ink 106 exceeds the threshold, then the apparatus may determine 508 whether the first ink 106 will be printed in a region of the page 102 that is likely to curl. Even if there is a high print density of the first ink 106, if the first ink is not to be printed in a region of the page that is likely to curl, the apparatus may print 510 the page 102 without modifying the first ink usage.

However, if the apparatus determines 508 that the first ink 106 will be printed in a region of the page 102 that is likely to curl, then the apparatus may print 512 the page 102 using the first ink 106 and a second ink 108 having anti-curl properties. In this case, the apparatus may print 512 the page 102 using a combination of the first ink 106 and the second ink 108 through either ink substitution or under printing. This may be accomplished as described in connection with FIG. 1.

FIG. 6 illustrates an example of ink substitution for curl compensation. In this example, a black ink lacks anti-curl properties (e.g., does not contain anti-curl agents). A cyan ink and magenta ink have anti-curl properties (e.g., contain anti-curl agents).

An example 601 of unmodified black ink on a printed page shows a number of black ink droplets (K) 605 deposited on a page. This is an example of unmodified ink usage, where the black ink is printed according to an unmodified colormap.

An example 603 of black ink with cyan and magenta substitution on a printed page shows a number of black ink droplets (K) 605 deposited on a page. However, a certain amount of cyan ink droplets (C) 607 and magenta ink droplets (M) 609 are substituted for the black ink droplets (K) 605. This is an example of ink substitution. In some examples, the black, cyan and magenta inks may be printed according to an alternate colormap. In other examples, the cyan and magenta inks may be substituted for the black ink without using an alternate colormap. Because the cyan ink droplets (C) 607 and magenta ink droplets (M) 609 include anti-curl properties, the ink substitution minimizes curl while maintaining the visual appearance of the black ink.

1. A method, comprising:
determining that curling is likely to occur on a printed page; and
printing the page using a first ink lacking anti-curl properties and a second ink having anti-curl properties in response to determining that curling is likely to occur.

2. The method of claim 1, wherein determining that curling is likely to occur on the printed page comprises determining that a print density of the first ink lacking anti-curl properties exceeds a threshold.

3. The method of claim 1, wherein determining that curling is likely to occur on the printed page comprises determining that the first ink lacking anti-curl properties will be printed in a region of the page that is likely to curl.

4. The method of claim 1, wherein determining that curling is likely to occur on the printed page comprises determining that the first ink lacking anti-curl properties will be printed in a region of the page but not in another region of the page.

5. The method of claim 1, wherein printing the page comprises substituting an amount of the first ink lacking anti-curl properties with an amount of the second ink having anti-curl properties during printing.

6. The method of claim 1, wherein printing the page comprises printing an amount of the first ink lacking anti-curl properties overlapping with an additional amount of the second ink having anti-curl properties.

7. A computing device, comprising:
a memory;
a processor coupled to the memory, wherein the processor is to:
determine that curling is likely to occur on a printed page; and
cause a printing device to print the page using a first ink lacking anti-curl properties and a second ink having anti-curl properties in response to determining that curling is likely to occur.

8. The computing device of claim 7, wherein the first ink comprises a black ink lacking an anti-curl agent and the second ink comprises a color ink that includes an anti-curl agent.

9. The computing device of claim 7, wherein the printing device is a page-wide inkjet printer.

10. The computing device of claim 7, wherein the processor causes the printing device to print the page using an alternate colormap that translates a color using the first ink lacking anti-curl properties to a combination of the first ink and the second ink having anti-curl properties.

11. The computing device of claim 7, wherein a combination of the first ink lacking anti-curl properties and the second ink having anti-curl properties is selected to match an original color.

12. The computing device of claim 7, wherein the processor further causes the printing device to print the page using the first ink lacking anti-curl properties and the second ink having anti-curl properties based on a finishing operation for the page.

13. A non-transitory machine-readable storage medium encoded with instructions executable by a processor, the machine-readable storage medium comprising:
instructions to determine a print density of a first ink lacking anti-curl properties on a page;
instructions to determine whether the first ink will be printed in a region of the page that is likely to curl; and
instructions to print the page using the first ink and a second ink having anti-curl properties based on the print density and the region of the first ink.

14. The machine-readable storage medium of claim 13, wherein the first ink and the second ink are used in response to determining that the print density of the first ink exceeds a threshold and the first ink will be printed in the region of the page that is likely to curl.

15. The machine-readable storage medium of claim 13, wherein the instructions to print the page further comprise instructions to print the page using the first ink, the second ink and a third ink having anti-curl properties.
